(19) United States
(12) Patent Application Publication
(10) Pub. No.: US 2022/0150579 A1
(43) Pub. Date: May 12, 2022

(54) METHOD FOR VIDEO PLAYBACK CONTROL, ELECTRONIC DEVICE AND STORAGE MEDIUM

(71) Applicant: BEIJING DAJIA INTERNET INFORMATION TECHNOLOGY CO., LTD., Beijing (CN)

(72) Inventors: Lei LIU, Beijing (CN); Keting CEN, Beijing (CN)

(21) Appl. No.: 17/466,030

(22) Filed: Sep. 3, 2021

(30) Foreign Application Priority Data
Nov. 10, 2020 (CN) 202011248233.5

(51) Int. Cl. H04N 21/4402; H04N 21/431

(52) U.S. Cl. CPC H04N 21/4402; H04N 21/4314

(57) ABSTRACT

A method for video playback control, an electronic device and a storage medium are provided. The method includes recognizing an attribute of a display control in a video playback interface; generating a playback parameter of a video to be played in response to the attribute; and playing the video in the video playback interface based on the playback parameter.

### CROSS REFERENCE TO RELATED APPLICATIONS

The present application is based on and claim priority under 35 U.S.C. § 119 to Chinese Application No. 202011248233.5, filed with the China National Intellectual Property Administration on Nov. 10, 2020, the entire content of which is incorporated herein by reference.

### FIELD

The disclosure relates to a technology field of video processing, and particularly, to a method for video playback control, an electronic device, and a storage medium.

### BACKGROUND

With development of the electronic technology, smart terminals with screens at various ratios arise. When using a smart terminal to play a video, it is an important problem how to enable the video to fit a display screen of the smart terminal.

In related art, after fitting the video into the display screen of the smart terminal, problems that the video is unclear due to excessive clipping or excessive magnifying of the video, a black slim bar exists in the middle of a top status bar and battery status bar or a bottom navigation bar and so on may occur.

### SUMMARY

The disclosure provides a method and an apparatus for video playback control, an electronic device and a storage medium.

According to embodiments of a first aspect of the disclosure, a method for controlling vide paly is provided. The method includes: recognizing an attribute of a display control in a video playback interface, generating a playback parameter of a video to be played in response to the attribute, and playing the video in the video playback interface based on the playback parameter.

According to embodiments of a second aspect of the disclosure, an apparatus for video playback control is provided. The apparatus includes a first recognizing module, a generating module and a control module. The recognizing module is configured to recognize an attribute of a display control in a video playback interface. The generating module is configured to generate a playback parameter of a video to be played in response to the attribute. The control module is configured to play the video in the video playback interface based on the playback parameter.

According to embodiments of a third aspect of the disclosure, an electronic device is provided. The electronic device includes a processor and a memory. The memory is configured to store instructions executable by the processor. The processor is configured to execute the instructions to implement the method for video playback control according to the embodiments of the first aspect.

According to embodiments of a fourth aspect of the disclosure, a storage medium is provided. When instructions in the storage medium are executed by a processor of an electronic device, the electronic device is caused to implement the method for video playback control according to the embodiments of the first aspect.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of the specification, illustrate embodiments consistent with the disclosure and, together with the description, serve to explain the principles of the disclosure and are not to be construed as limiting the disclosure.

FIG. 1 is a flow chart illustrating a method for video playback control according to an embodiment.

FIG. 2 is a schematic diagram illustrating a second height of a playback area for playing a video in a case that a first height of a first display area of a display control is less than a predetermined threshold and a navigation bar is in a transparent state according to an embodiment.

FIG. 3 is a schematic diagram illustrating a second height of a playback area for playing a video in a case that a first height of a first display area of a display control is greater than or equal to a predetermined threshold and a navigation bar is in a non-transparent state with a predetermined color according to an embodiment.

FIG. 4 is a flow chart illustrating a method of recognizing subtitles of a video to be played according to an embodiment.

FIG. 5 is a schematic diagram illustrating a second height of a playback area for playing a video in a case that a first height of a first display area of a display control is less than a predetermined threshold, a navigation bar is in a transparent state and subtitles need to be clipped according to an embodiment.

FIG. 6 is a schematic diagram illustrating a second height of a playback area for playing a video in a case that a first height of a first display area of a display control is greater than or equal to a predetermined threshold, a navigation bar is in a non-transparent state with a predetermined color and subtitles need to be clipped according to an embodiment.

FIG. 7 is a block diagram illustrating an apparatus for video playback control according to an embodiment.

FIG. 8 is a block diagram illustrating an electronic device according to an embodiment.

### DETAILED DESCRIPTION

In order to make the technical solution of the disclosure better understood, the technical solution in embodiments of the disclosure will be clearly and completely described below with reference to the accompanying drawings.

It should be noted that the terms “first”, “second” and the like in the specification and claim of the disclosure and in the foregoing drawings are used for distinguishing between similar elements and not necessarily for describing a certain sequential or chronological order. It is to be understood that the data so used is interchangeable under appropriate circumstances such that embodiments of the disclosure described herein are capable of operation in other sequences than those illustrated or described herein. Implementations described in the exemplary embodiments below do not represent all implementations consistent with the disclosure. Rather, they are merely examples of the apparatus and method consistent with certain aspects of the disclosure, as detailed in the appended claims.

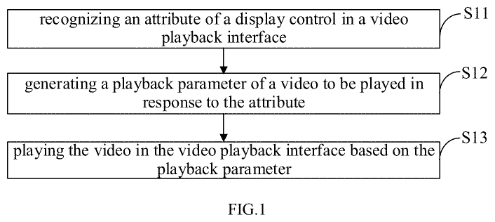

FIG. 1 is a flow chart illustrating a method for video playback control according to an embodiment. As illustrated in FIG. 1, the method is applicable in an electronic device. The method may include the following.

In block S11, an attribute of a display control in a video playback interface is recognized

A device for playing a video may be referred to as a player device, such as a phone, a pad etc.. The video playback interface may be a screen of the player device. The attribute of the display control may include a first height of a first display area of the display control and a state of a navigation bar for video playback control (such as speeding, backspacing, pausing, starting).

As an implementation, recognizing the attribute of the display control in the video playback interface may at least include one of the followings.

The attribute of the display control is obtained by recognizing the first height, in which the attribute is configured to indicate that the first height is less than a predetermined threshold or indicate that the first height is greater than or equal to the predetermined threshold. The predetermined threshold may be set according to actual requirements, for example, (17:9)*W, where W is the width of display area of the screen.

The attribute of the display control is obtained by recognizing the state of the navigation bar, in which the attribute is configured to indicate that the navigation bar is in a transparent state or indicate that the navigation bar is in a non-transparent state with a predetermined color. The non-transparent state with the predetermined color may be a black state.

In other words, in the embodiment of the present disclosure, the first height is recognized to determine whether the first height is less than the predetermined threshold or greater than or equal to the predetermined threshold. The state of the navigation bar is recognized to determine whether the navigation bar is in the transparent state or in the black state.

In block S12, in response to the attribute of the display control, a playback parameter of a video to be played is generated.

The playback parameter of the video to be played may be a second height of a playback area for playing the video to be played.

In block S13, the video is played in the video playback interface based on the playback parameter.

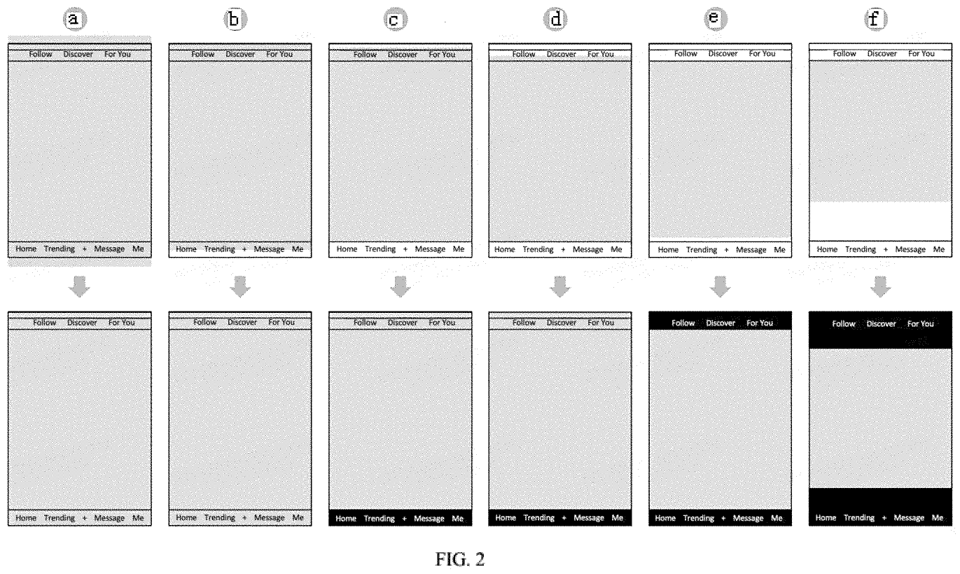

As an implementation, with reference to FIG. 2, in a case that the first height is less than the predetermined threshold and the navigation bar is in the transparent state, the first height of the first display area of the display control is equal to a height of the display control, i.e., in full-screen mode. In other words, the first display area refers to a whole display area of the display control.

With reference to (a) in FIG. 2, in a case that a third height of an image area of the video to be played (it should be noted that the third height is different from the second height, the third height refers to a height of the image area of the video itself while the second height refers to a height of a playback area used for playing the video) is greater than or equal to the first height, the video to be played is fitted based on a width of the first display area of the display control and the second height is determined. In this case, the second height is equal to the first height. Video clips with the same height are clipped from the top and the bottom of the video to be played. A battery status bar, a status bar and the navigation bar are controlled to be in the transparent state, such that the video to be played may fill up the screen as possible and a view experience of a user may be improved.

With reference to (b) in FIG. 2, in a case that the third height is greater than a difference between the first height and a fourth height of the navigation bar but less than or equal to the first height, the video to be played is scaled proportionally to fill up the video playback interface, the video is aligned at center and the second height is determined. In this case, the second height is equal to the first height. Video clips with the same width are clipped from the left and the right of the video to be played. The battery status bar, the status bar and the navigation bar are controlled to be in the transparent state, such that the video to be played may fill up the screen as possible and the view experience of a user may be improved.

With reference to (c) in FIG. 2, in a case that the third height is greater than a difference between the first height and a sum of the fourth height and a fifth height of the battery status bar but less than or equal to the difference between the first height and the fourth height, the video to be played is scaled proportionally to fill up the video playback interface, the video is aligned at center and the second height is determined. In this case, the second height is equal to the difference between the first height and the fourth height. Video clips with the same width are clipped from the left and the right of the video to be played. The battery status bar and the status bar are controlled to be in the transparent state and the navigation bar is controlled to be in the non-transparent state with the predetermined color (for example, black) or in the transparent state, such that the video to be played may be displayed in the screen maximally and the view experience of a user may be improved.

With reference to (d) in FIG. 2, in a case that the third height is greater than a difference between the first height and a sum of the fourth height, the fifth height and a sixth height of the status bar but less than or equal to the difference between the first height and the sum of the fourth height and the fifth height, the video to be played is scaled proportionally to fill up the video playback interface, the video is aligned at center and the second height is determined. In this case, the second height is equal to the difference between the first height and the fourth height. Video clips with the same width are clipped from the left and the right of the video to be played. The battery status bar and the status bar are controlled to be in the transparent state and the navigation bar is controlled to be in the non-transparent state with the predetermined color or in the transparent state, such that the video to be played may be displayed in the screen maximally and the view experience of a user may be improved.

With reference to (e) in FIG. 2, in a case that the third height is greater than a difference between the first height and a predetermined multiple (which is greater than or equal to 2) of a sum of the fifth height and the sixth height but less than or equal to the difference between the first height and the sum of the fourth height, the fifth height and the sixth height, the video to be played is scaled proportionally to fill up the video playback interface, the video is aligned at center and the second height is determined. In this case, the second height is equal to the difference between the first height and the sum of the fourth height, the fifth height and the sixth height. Video clips with the same width are clipped from the left and the right of the video to be played. The battery status bar, the status bar and the navigation bar are controlled to be in the non-transparent state with the predetermined color or in the transparent state, such that the video to be played may be displayed in the screen maximally and the view experience of a user may be improved.

With reference to (f) in FIG. 2, in a case that the third height is less than or equal to the difference between the first height and the predetermined multiple of the sum of the fifth height and the sixth height, the video to be played is aligned at center and the second height is determined. In this case, the second height is unchanged, which is equal to the video height. An area other than the playback area for playing the video to be played in the first display area is controlled to be in the non-transparent state with the predetermined color, such that the video to be played may be displayed in the screen maximally and the view experience of a user may be improved.

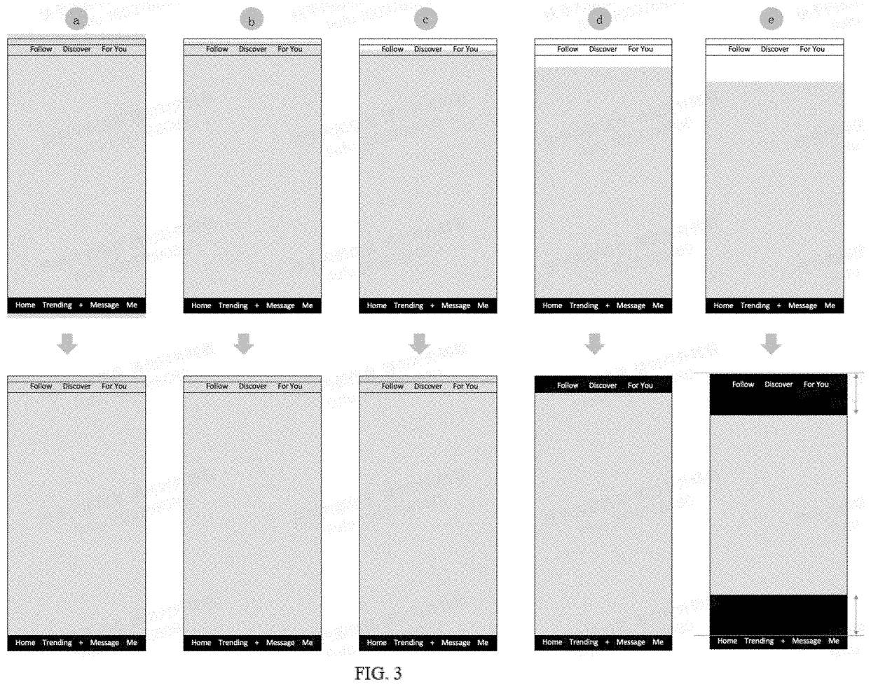

As an implementation, with reference to FIG. 3, in a case that the first height is greater than or equal to the predetermined threshold and the navigation bar is in the non-transparent state with the predetermined color, the first height of the first display area of the display control is equal to a difference between the height of the display control and the fourth height. In other words, the first display area refers to the whole display area excluding an area of displaying the navigation bar of the display control.

With reference to (a) in FIG. 3, in a case that the third height is greater than or equal to the first height, it indicates that the video to be played spans a wide range in a longitudinal direction of the screen. In this case, in order to make the video to be played fill up the full screen as possible, the video to be played is not scaled in the height direction but the video to be played is fitted based on the width of the first display area of the display control and the second height is determined. In this case, the second height is equal to the first height. Video clips with the same height are clipped from the top and the bottom of the video to be played. The battery status bar and the status bar are controlled to be in the transparent state, such that the video to be played may fill up the screen as possible and the view experience of a user may be improved.

With reference to (b) in FIG. 3, in a case that the third height is greater than a difference between the first height and the fifth height but less than the first height, the video to be played is scaled proportionally to fill up the video playback interface, the video is aligned at center and the second height is determined. In this case, the second height is equal to the first height. Video clips with the same width are clipped from the left and the right of the video to be played. The battery status bar and the status bar are controlled to be in the transparent state, such that the video to be played may fill up the screen as possible and the view experience of a user may be improved.

With reference to (c) in FIG. 3, in a case that the third height is greater than a difference between the first height and a sum of the sixth height and the fifth height but less than or equal to the difference between the first height and the fifth height, the video to be played is scaled proportionally to fill up the first display area, the video is aligned at center and the second height is determined. In this case, the second height is equal to the first height. Video clips with the same width are clipped from the left and the right of the video to be played. The battery status bar and the status bar are controlled to be in the transparent state, such that the video to be played may fill up the screen as possible and the view experience of a user may be improved.

With reference to (d) in FIG. 3, in a case that the third height is greater than a difference between the first height and the predetermined multiple (which is greater than or equal to 2) of the sum of the fifth height and the sixth height but less than or equal to the difference between the first height and the sum of the fifth height and the sixth height, the video to be played is scaled proportionally to fill up the first display area, the video is aligned at center and the second height is determined. In this case, the second height is equal to the difference between the first height and the sum of the fifth height and the sixth height. Video clips with the same width are clipped from the left and the right of the video to be played. The battery status bar and the status bar are controlled to be in the non-transparent state with the predetermined color, such that the video to be played may be displayed in the screen maximally and the view experience of a user may be improved.

With reference to (e) in FIG. 3, in a case that the third height is less than or equal to the difference between the first height and the predetermined multiple of the sum of the fifth height and the sixth height, the second height is equal to the video height. A distance between the top of the video to be played and the top of the first display area is equal to a distance between the bottom of the video to be played and the bottom of the first display area. An area other than the playback area for playing the video to be played in the first display area is controlled to be in the non-transparent state with the predetermined color, such that the video to be played may be displayed in the screen maximally and the view experience of a user may be improved. According to the method for video playback control in the embodiment of the present disclosure, the attribute of the display control in the video playback interface is recognized, the playback parameter of the video to be played is generated in response to the attribute, and the video is played in the video playback interface based on the playback parameter. In this way, the problem that the video is displayed in a poor effect when fitting the video into the interface which is caused by limitations on the display control in different video playback interfaces may be avoided, and the video may be automatically fitted into the interface by breaking through the limitations on the display control in different video playback interfaces, thereby effectively improving a display effect of the video play.

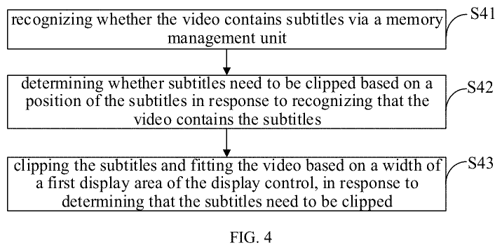

In order to further effectively improve the view experience of the user, in an embodiment, as illustrated in FIG. 4, after the block S11 of recognizing the attribute of the display control in the video playback interface, the method further includes the following.

In block S41, it is recognized by a memory management unit whether the video to be played contains subtitles.

In block S42, in response to recognizing that the video to be played contains the subtitles, it is determined whether the subtitles need to be clipped based on a position of the subtitles.

In block S43, in response to determining that the subtitles need to be clipped, after clipping the subtitles, the video to be played is fitted based on a width of a first display area of the display control.

It may be understood that, when using the display control to play the video, the video will be played based on the above blocks S11-513 without considering the subtitles in the video. In consideration of the subtitles in the video, blocks S11-S13 are followed by blocks S41-S43. It is recognized by the memory management unit whether the video to be played contains subtitles, when the video to be played contains the subtitles, it is determined whether the subtitles need to be clipped based on the position of the subtitles, if the subtitles need not to be clipped, the video is played based on the above blocks S12-S13, if the subtitles need to be clipped, block S43 is executed, i.e., the subtitles are clipped maximally and the video to be played is fitted based on the width of the first display area of the display control, and then blocks S12-S13 are executed.

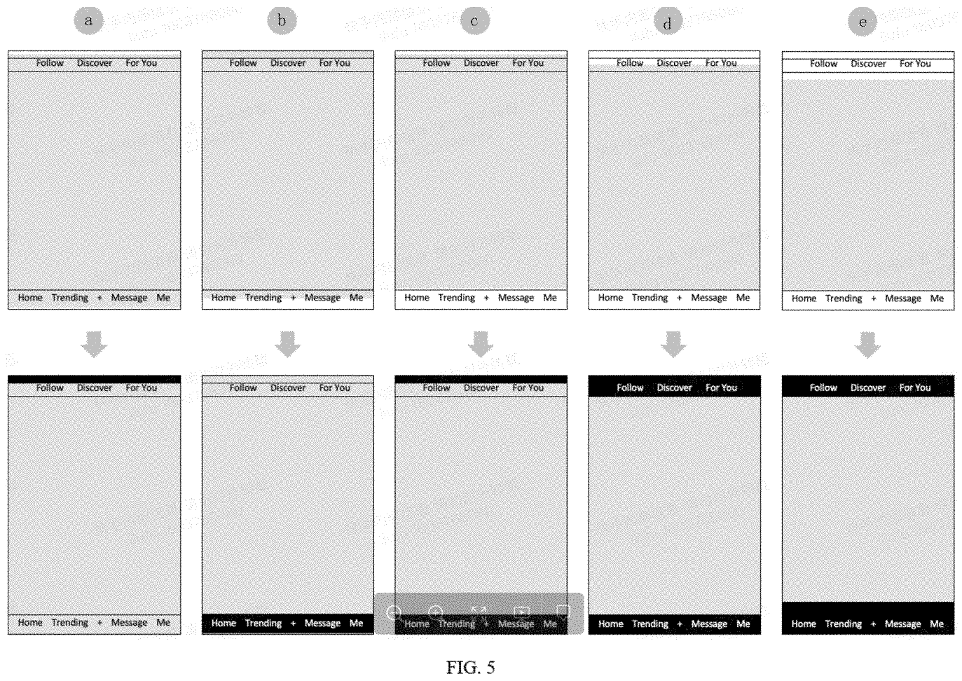

As an implementation, with reference to FIG. 5, in a case that a first height of the first display area of the display control is less than the predetermined threshold and the navigation bar is in the transparent state, the first height of the first display area of the display control is equal to a height of the display control. In other words, the first display area refers to a whole display area of the display control. The predetermined threshold may be set according to actual requirements, for example, (17:9)*W, where W is a width of the first display area.

With reference to (a) in FIG. 5, in a case that a seventh height of an image area of the fitted video to be played is greater than or equal to a difference between the first height and a fifth height of the battery status bar but less than or equal to the first height, a second height of a playback area for playing the video (it should be noted that the seventh height is different from the second height, the seventh height refers to a height of the image area of the fitted video itself while the second height refers to a height of a playback area used for playing the video) is determined as the difference between the first height and the fifth height. Video clips with the same height are clipped from the top and the bottom of the video to be played. The battery status bar is controlled in the non-transparent state with the predetermined color, and the status bar and the navigation bar are controlled to be in the transparent state, such that the video to be played may be minimalized with the complete subtitles and the view experience of a user may be improved.

With reference to (b) in FIG. 5, in a case that the seventh height is greater than or equal to a difference between the first height and a fourth of the navigation bar but less than or equal to the difference between the first height and the fifth height, the second height is determined as the difference between the first height and the fourth height. Video clips with the same height are clipped from the top and the bottom of the video to be played. The battery status bar and the status bar are controlled to be in the transparent state and the navigation bar is controlled to be in the non-transparent state with the predetermined color, such that the video to be played may be minimalized with the complete subtitles and the view experience of a user may be improved.

With reference to (c) in FIG. 5, in a case that the seventh height is greater than a difference between the first height and a sum of the fourth height and the fifth height but less than or equal to the difference between the first height and the fourth height, the second height is determined as the difference between the first height and the sum of the fourth height and the fifth height. Video clips with the same height are clipped from the top and the bottom of the video to be played. The status bar is controlled to be in the transparent state, the battery status bar and the navigation bar are controlled to be in the non-transparent state with the predetermined color, such that the video to be played may be minimalized with the complete subtitles and the view experience of a user may be improved.

With reference to (d) in FIG. 5, in a case that the seventh height is greater than or equal to a difference between the first height and a sum of the fourth height, the fifth height and a sixth height of the status bar but less than the difference between the first height and the sum of the fourth height and the fifth height, the second height is determined as the difference between the first height and the sum of the fourth height, the fifth height and the sixth height. Video clips with the same height are clipped from the top and the bottom of the video to be played. The battery status bar, the status bar and the navigation bar are controlled to be in the non-transparent state with the predetermined color, such that the video to be played may be minimalized with the complete subtitles and the view experience of a user may be improved.

With reference to (e) in FIG. 5, in a case that the seventh height is less than or equal to the difference between the first height and the sum of the fourth height, the fifth height and the sixth height but greater than a difference between the first height and twice of the sum of the fifth height and the sixth height, the second height is determined as the video height of the fitted video. The top of the video is aligned with the bottom of the status bar, i.e., the video is pushed upward without clipping. An area other than the playback area for playing the video to be played in the first display area is controlled to be in the non-transparent state with the predetermined color, such that the view experience of a user may be further improved.

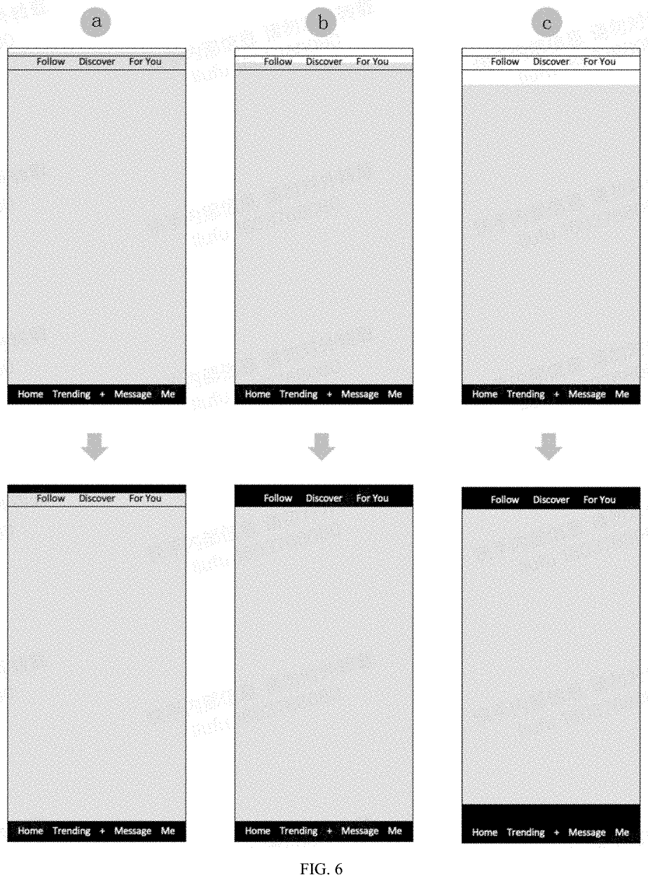

As an implementation, with reference to FIG. 6, in a case that the first height is greater than or equal to the predetermined threshold and the navigation bar is in the non-transparent state with the predetermined color, the first height of the first display area of the display control is equal to a difference between the height of the display control and the fourth height. In other words, the first display area refers to the whole display area excluding an area of displaying the navigation bar of the display control.

With reference to (a) in FIG. 6, in a case that the seventh height is greater than or equal to a difference between the first height and the fifth height but less than or equal to the first height, the second height is determined as the difference between the first height and the fifth height. Video clips with the same height are clipped from the top and the bottom of the video to be played. The battery status bar and the navigation bar are controlled to be in the non-transparent state, the status bar is controlled to be in the transparent state, such that the view experience of a user may be further improved.

With reference to (b) in FIG. 6, in a case that the seventh height is greater than or equal to a difference between the first height and the fourth height but less than or equal to the difference between the first height and the fifth height, the second height is determined as the difference between the first height and the sum of the fourth height and the fifth height. Video clips with the same height are clipped from the top and the bottom of the video to be played. The battery status bar, the status bar and the navigation bar are controlled to be in the non-transparent state, such that the view experience of a user may be further improved.

With reference to (c) in FIG. 6, in a case that the seventh height is greater than a difference between the first height and twice of the sum of the fifth height and the sixth height but less than the difference between the first height and the sum of the fifth height and the sixth height, the second height is determined as the video height of the fitted video. The top of the video is aligned with the bottom of the status bar, i.e., the video is pushed upward without clipping. An area other than the playback area for playing the video to be played in the first display area is controlled to be in the non-transparent state with the predetermined color, such that the view experience of a user may be further improved.

It should be noted that, when the memory management unit recognizes that the video to be played contains subtitles and the subtitles are long, for example, the subtitles contact the top of the battery status bar and the bottom of the navigation bar, the video to be played is clipped in the height direction.

According to the method for video playback control in the embodiment of the present disclosure, the attribute of the display control in the video playback interface is recognized, the memory management unit is used to recognize whether the video to be played contains subtitles, if yes, it is determined whether the subtitles need to be clipped based on the position of the subtitles. If the subtitles need not to be clipped, the playback parameter of the video to be played is generated in response to the attribute, and the video is played in the video playback interface based on the playback parameter. If the subtitles need to be clipped, the subtitles are clipped maximally, the video to be played is fitted based on the width of the first display area of the display control, the playback parameter of the video to be played is generated in response to the attribute, and the video is played in the video playback interface based on the playback parameter. In this way, the problem that the video is displayed in a poor effect when fitting the video into the interface which is caused by limitations on the display control in different video playback interfaces may be avoided, and the video may be automatically fitted into the interface by breaking through the limitations on the display control in different video playback interfaces, thereby effectively improving a display effect of the video play.

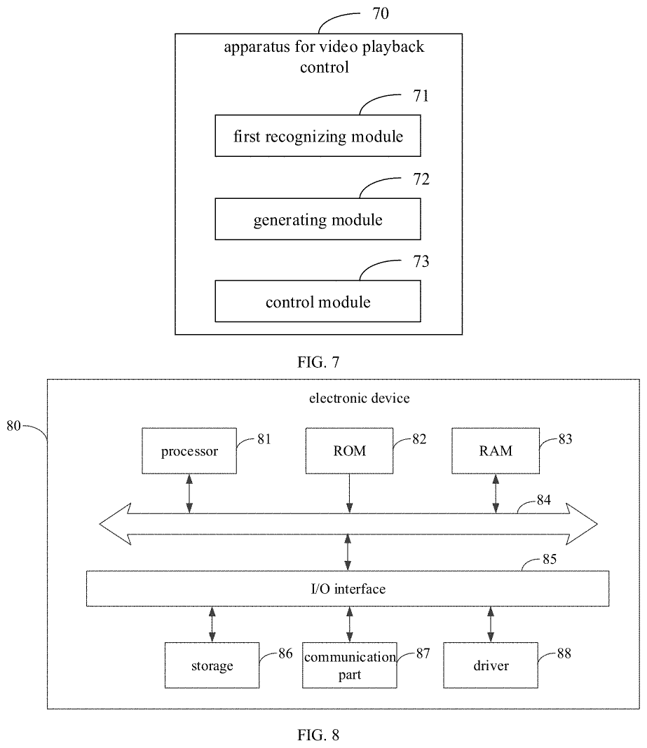

FIG. 7 is a block diagram illustrating an apparatus for video playback control according to an embodiment of the present disclosure. As illustrated in FIG. 7, the apparatus 70 may include a first recognizing module 71, a generating module 72 and a control module 73.

The recognizing module 71 is configured to recognize an attribute of a display control in a video playback interface.

The generating module 72 is configured to generate a playback parameter of a video to be played in response to the attribute.

The control module 73 is configured to play the video in the video playback interface based on the playback parameter.

In a possible implementation, the first recognizing module 71 includes a first recognizing unit and a second recognizing unit.

The first recognizing unit is configured to obtain the attribute of the display control by recognizing a first height of a first display area of the display control. The attribute of the display control is configured to indicate that the first height is less than a predetermined threshold or indicate that the first height is greater than or equal to the predetermined threshold.

The second recognizing unit is configured to obtain the attribute of the display control by recognizing a state of a navigation bar. The attribute is configured to indicate that the navigation bar is in a transparent state or indicate that the navigation bar is in a non-transparent state with a predetermined color.

In a possible implementation of the embodiment of the present disclosure, the playback parameter is a second height of a playback area for playing the video. In a case that the first height is less than the predetermined threshold and the navigation bar is in the transparent state, the generating module 72 includes a first determining unit configured to fit the video based on a width of the first display area, determine that the second height is equal to the first height and set a battery status bar, a status bar and the navigation bar to be in the transparent state, in response to a third height of an image area of the video being greater than or equal to the first height; a second determining unit configured to scale the video to be played proportionally, determine that the second height is equal to the first height and setting the battery status bar, the status bar and the navigation bar to be in the transparent state, in response to the third height being greater than a difference between the first height and a fourth height of the navigation bar but less than or equal to the first height; a third determining unit configured to scale the video to be played proportionally, determine that the second height is equal to the difference between the first height and the fourth height, set the battery status bar and the status bar to be in the transparent state and setting the navigation bar to be in the non-transparent state with the predetermined color, in response to the third height being greater than a difference between the first height and a sum of the fourth height and a fifth height of the battery status bar but less than or equal to the difference between the first height and the fourth height; a fourth determining unit configured to scale the video to be played proportionally, determine that the second height is equal to the difference between the first height and the fourth height, set the battery status bar and the status bar to be in the transparent state and setting the navigation bar to be in the non-transparent state with the predetermined color, in response to the third height being greater than a difference between the first height and a sum of the fourth height, the fifth height and a sixth height of the status bar but less than or equal to the difference between the first height and the sum of the fourth height and the fifth height; a fifth determining unit configured to scale the video to be played proportionally, determine that the second height is equal to the difference between the first height and the sum of the fourth height, the fifth height and the sixth height, set the battery status bar, the status bar and the navigation bar to be in the non-transparent state with the predetermined color in response to the third height being greater than a difference between the first height and a predetermined multiple of a sum of the fifth height and the sixth height but less than or equal to the difference between the first height and the sum of the fourth height, the fifth height and the sixth height, wherein the predetermined multiple is greater than or equal to 2; a sixth determining unit configured to determine that the second height is equal to the third height, set an area of the first display area excluding the playback area to be in the non-transparent state with the predetermined color, in response to the third height being less than or equal to the difference between the first height and the predetermined multiple of the sum of the fifth height and the sixth height.

In a possible implementation of the embodiment of the present disclosure, the playback parameter is a second height of a playback area for playing the video. In a case that the first height is greater than or equal to the predetermined threshold and the navigation bar is in the non-transparent state with the predetermined color, the generating module 72 includes a seventh determining unit configured to fit the video based on a width of the first display area, determine that the second height is equal to the first height and setting a battery status bar and a status bar to be in the transparent state, in response to a third height of an image area of the video being greater than or equal to the first height; an eighth determining unit configured to scale the video to be played proportionally, determine that the second height is equal to the first height and set the battery status bar and the status bar to be in the transparent state in response to the third height being greater than a difference between the first height and a fifth height of the battery status bar but less than the first height; a ninth determining unit configured to scale the video to be played proportionally, determine that the second height is equal to the first height, set the battery status bar and the status bar to be in the transparent state in response to the third height being greater than a difference between the first height and a sum of a sixth height of the status bar and the fifth height but less than or equal to the difference between the first height and the fifth height; and/or a tenth determining unit configured to scale the video to be played proportionally, determine that the second height is equal to the difference between the first height and the sum of the fifth height and the sixth height, set the battery status bar and the status bar to be in the non-transparent state with the predetermined color in response to the third height being greater than a difference between the first height and a predetermined multiple of the sum of the fifth height and the sixth height but less than or equal to the difference between the first height and the sum of the fifth height and the sixth height, wherein the predetermined multiple is greater than or equal to 2; and/or an eleventh determining unit configured to determine that the second height is equal to the third height, setan area of the first display area excluding the playback area to be in the non-transparent state with the predetermined color in response to the third height being less than or equal to the difference between the first height and the predetermined multiple of the sum of the fifth height and the sixth height.

In a possible implementation of the embodiment of the present disclosure, the apparatus may further include a second recognizing module, a first determining module and a second determining module.

The second recognizing module is configured to recognize whether the video to be played contains subtitles by a memory management unit after the first recognizing module 71 recognizes the attribute of the display control in the video play interface.

The first determining module is configured to determine whether the subtitles need to be clipped in response to recognizing that the video to be played contains the subtitles. The second determining module is configured to fit the video to be played based on a width of the first display area after clipping the subtitles in response to determining that the subtitles need to be clipped.

In a possible implementation of the embodiment of the present disclosure, the playback parameter is a second height of a playback area for playing the video. In a case that the first height is less than the predetermined threshold and the navigation bar is in the transparent state, the generating module 72 includes a twelfth determining unit configured to determine that the second height is equal to a difference between the first height and a fifth height of the battery status bar, set a battery status bar to be in the non-transparent state with the predetermined color and set a status bar and the navigation bar to be in the transparent state in response to a seventh height of an image area of the fitted video being greater than or equal to the difference between the first height and the fifth height but less than or equal to the first height; a thirteen determining unit configured to determine that the second height is equal to a difference between the first height and a fourth height of the navigation bar, set the battery status bar and the status bar to be in the transparent state and set the navigation bar to be in the non-transparent state with the predetermined color in response to the seventh height being greater than or equal to the difference between the first height and the fourth height but less than or equal to the difference between the first height and the fifth height; a fourteenth determining unit configured to determine that the second height is equal to a difference between the first height and a sum of the fourth height and the fifth height, set the status bar to be in the transparent state and set the battery status bar and the navigation bar to be in the non-transparent state with the predetermined color in response to the seventh height being greater than the difference between the first height and the sum of the fourth height and the fifth height but less than or equal to the difference between the first height and the fourth height; a fifteenth determining unit configured to determine that the second height is equal to a difference between the first height and a sum of the fourth height, the fifth height and a sixth height of the status bar, and set the battery status bar, the status bar and the navigation bar to be in the non-transparent state with the predetermined color in response to the seventh height being greater than or equal to the difference between the first height and the sum of the fourth height, the fifth height and the sixth height but less than the difference between the first height and the sum of the fourth height and the fifth height; a sixteenth determining unit configured to determine that the second height is equal to the seventh height, and set an area of the first display area excluding the playback area to be in the non-transparent state with the predetermined color, in response to the seventh height being less than or equal to the difference between the first height and the sum of the fourth height, the fifth height and the sixth height but greater than a difference between the first height and a predetermined multiple of the sum of the fifth height and the sixth height, wherein the predetermined multiple is greater than or equal to 2.

In a possible implementation of the embodiment of the present disclosure, the playback parameter is a second height of a playback area for playing the video. In a case that the first height is greater than or equal to the predetermined threshold and the navigation bar is in the non-transparent state with the predetermined color, the generating module 72 includes a seventeenth determining unit configured to determine that the second height is equal to a difference between the first height and a fifth height of the battery status bar, set a battery status bar and the navigation bar to be in the non-transparent state with the predetermined color and setting a status bar to be in the transparent state, in response to a seventh height of an image area of the fitted video being greater than or equal to the difference between the first height and the fifth height but less than or equal to the first height; an eighteenth determining unit configured to determine that the second height is equal to a difference between the first height and a sum of a fourth height of the navigation bar and the fifth height, set the battery status bar, the status bar and the navigation bar to be in the non-transparent state with the predetermined color in response to the seventh height being greater than or equal to a difference between the first height and the fourth height but less than or equal to the difference between the first height and the fifth height; a nineteenth determining unit configured to determine that the second height is equal to the seventh height, and set an area of the first display area excluding the playback area to be in the non-transparent state with the predetermined color, in response to the seventh height being greater than a difference between the first height and a predetermined multiple of a sum of the fifth height and a sixth height of the status bar but less than the difference between the first height and the sum of the fifth height and the sixth height, wherein the predetermined multiple is greater than or equal to 2.

In an actual usage, the apparatus for video playback control may be configured in an electronic device to implement the above method for video playback control. It should be noted that, with regard to the apparatus in the above foregoing embodiment, a specific way of performing operations by each module has been described in the method embodiments in detail, which are not described here.

With the apparatus for video playback control according to the embodiments of the disclosure, the attribute of the display control in the video playback interface is recognized by the first recognizing module, the playback parameter of the video to be played is generated by the generating module in response to the attribute of the display control and the control module plays the video in the video playback interface based on the playback parameter. Further, the second recognizing module may recognize whether the video to be played contains subtitles via the memory management unit after the first recognizing module recognizes the attribute of the display control, the first determining module determines whether the subtitles need to be clipped based on the position of the subtitles after the subtitles are recognized If it is determined that the subtitles need to be clipped, the second determining module fits the video to be played based on the width of the first display area of the display control after the subtitles are clipped. In this way, the problem that the video is displayed in a poor effect when fitting the video into the interface which is caused by limitations on the display control in different video playback interfaces may be avoided, and the video may be automatically fitted into the interface by breaking through the limitations on the display control in different video playback interfaces, thereby effectively improving a display effect of the video play.

In order to implement the above embodiments, the present disclosure further provides an electronic device.

The electronic device includes a processor and a memory configured to store instructions executable by the processor. The processor is configured to execute the instructions to implement the method for video playback control described above.

In order to implement the above embodiments, the present disclosure further provides a storage medium.

When instructions in the storage medium are executed by a processor of an electronic device, the electronic device is caused to implement the method for video playback control described above.

FIG. 8 is a block diagram illustrating an electronic device 200 according to an embodiment of the present disclosure. The electronic device shown in FIG. 8 is merely an example and should not be construed to limit the functions and usage scope of embodiments of the present disclosure.

As illustrated in FIG. 8, the electronic device 80 includes a processor 81 configured to execute various functional applications and data processing based on programs stored in a ROM (Read Only Memory) 82 or programs loaded from a storage 86 to a RAM (Random Access Memory) 83. In the RAM 83, various programs and data required for operations of the electronic device 80 are stored. The processor 81, the ROM 82 and the RAM 83 are connected to each other via a bus 84. An input/output (I/O) interface 85 is also connected to the bus 84.

The following components are connected to the I/O interface 85. The storage 86 includes a hard disc and so on. A communication part 87 includes a network interface card such as LAN (Local Area Network) card, modem and so on. The communication part 87 performs communications via the network such as Internet. A driver 88 is also connected to the I/O interface 85 according to actual requirements.

In particular, according to the embodiments of the present disclosure, the above processes described with reference to the accompanying drawings may be implemented as computer software programs. For example, the embodiments of the present disclosure include the computer programs carried on a computer-readable medium. The computer programs include program codes for executing the method shown in the flow chart. In such embodiments, the computer programs may be downloaded from the network via the communication part 87 and installed. When the computer programs are executed by the processor 81, the above functions in the present method may be implemented.

In an embodiment, a storage medium including instructions is provided, for example, a memory including instructions. The instructions may be executed by the processor 81 in the electronic device 80 to implement the above mentioned method. Alternatively, the storage medium may be a non-transitory computer-readable media such as read-only memory (ROM), random-access memory (RAM), CD-ROMs, magnetic tapes, floppy disks, and optical data storage devices.

In the present disclosure, the computer-readable storage medium may be a volatile media including or storing programs. The programs may be used by an instruction execution system, a device, an apparatus or a combination thereof. In the present disclosure, a computer-readable signal medium may include a data signal propagated in a baseband or as a part of carrier, carrying computer-readable program codes. Such data signal may be in any form, including but not limited to an electromagnetic signal, an optical signal or any combination thereof. The computer-readable signal medium may any computer-readable medium other than the computer-readable storage medium. The computer-readable medium may send, spread or transmit the programs used by an instruction execution system, a device, an apparatus or a combination thereof. The programs code included in the computer-readable medium may be transmitted in any appropriate medium, including but not limited to wireless, electric wire, cable, RF or any combination thereof.

Those skilled in the art may easily conceive of other embodiments of the disclosure by considering the description and practicing the disclosure disclosed herein. This disclosure is intended to cover any variations, uses, or adaptive changes that follow the general principles of this disclosure and include common general knowledge or customary technical means in the technical field not disclosed in this disclosure. The description and examples are to be considered exemplary only, and the true scope and spirit of this disclosure are disclosed by the claims.

It should be understood that the disclosure is not limited to the precise structure that has been described above and shown in the drawings, and various modifications and changes can be made without departing from the scope thereof. The scope of the disclosure is limited only by the appended claims.

What is claimed is:

1. A method for video playback control, comprising:
recognizing an attribute of a display control in a video playback interface;
generating a playback parameter of a video to be played in response to the attribute; and
playing the video in the video playback interface based on the playback parameter.

2. The method of claim 1, said recognizing an attribute of a display control in a video playback interface comprising at least one of:
obtaining the attribute of the display control by recognizing a first height of a first display area of the display control, wherein the attribute of the display control is configured to indicate that the first height is less than a predetermined threshold or indicate that the first height is greater than or equal to the predetermined threshold;
obtaining the attribute of the display control by recognizing a state of a navigation bar, wherein the attribute of the display control is configured to indicate that the navigation bar is in a transparent state or indicate that the navigation bar is in a non-transparent state with a predetermined color.

3. The method of claim 2, wherein, the playback parameter is a second height of a playback area for playing the video and in a case that the first height is less than the predetermined threshold and the navigation bar is in the transparent state, said generating a playback parameter of a video to be played in response to the attribute comprising at least one of:
fitting the video based on a width of the first display area, determining that the second height is equal to the first height and setting a battery status bar, a status bar and the navigation bar to be in the transparent state, in response to a third height of an image area of the video being greater than or equal to the first height;
scaling the video proportionally, determining that the second height is equal to the first height and setting the battery status bar, the status bar and the navigation bar to be in the transparent state, in response to the third height being greater than a difference between the first height and a fourth height of the navigation bar but less than or equal to the first height;
scaling the video proportionally, determining that the second height is equal to the difference between the first height and the fourth height, setting the battery status bar and the status bar to be in the transparent state and setting the navigation bar to be in the non-transparent state with the predetermined color, in response to the third height being greater than a difference between the first height and a sum of the fourth height and a fifth height of the battery status bar but less than or equal to the difference between the first height and the fourth height;
scaling the video proportionally, determining that the second height is equal to the difference between the first height and the fourth height, setting the battery status bar and the status bar to be in the transparent state and setting the navigation bar to be in the non-transparent state with the predetermined color, in response to the third height being greater than a difference between the first height and a sum of the fourth height, the fifth height and a sixth height of the status bar but less than or equal to the difference between the first height and the sum of the fourth height and the fifth height;
scaling the video proportionally, determining that the second height is equal to the difference between the first height and the sum of the fourth height, the fifth height and the sixth height, setting the battery status bar, the status bar and the navigation bar to be in the non-transparent state with the predetermined color, in response to the third height being greater than a difference between the first height and a predetermined multiple of a sum of the fifth height and the sixth height but less than or equal to the difference between the first height and the sum of the fourth height, the fifth height and the sixth height, wherein the predetermined multiple is greater than or equal to 2;
determining that the second height is equal to the third height, setting an area of the first display area excluding the playback area to be in the non-transparent state with the predetermined color, in response to the third height being less than or equal to the difference between the first height and the predetermined multiple of the sum of the fifth height and the sixth height.

4. The method of claim 2, wherein the playback parameter is a second height of a playback area for playing the video and in a case that the first height is greater than or equal to the predetermined threshold and the navigation bar is in the non-transparent state with the predetermined color, said generating a playback parameter of a video to be played in response to the attribute comprising at least one of:
fitting the video based on a width of the first display area, determining that the second height is equal to the first height and setting a battery status bar and a status bar to be in the transparent state, in response to a third height of an image area of the video being greater than or equal to the first height;
scaling the video proportionally, determining that the second height is equal to the first height and setting the battery status bar and the status bar to be in the transparent state, in response to the third height being greater than a difference between the first height and a fifth height of the battery status bar but less than the first height;
scaling the video proportionally, determining that the second height is equal to the first height, and setting the battery status bar and the status bar to be in the transparent state, in response to the third height being greater than a difference between the first height and a sum of a sixth height of the status bar and the fifth height but less than or equal to the difference between the first height and the fifth height;
scaling the video proportionally, determining that the second height is equal to the difference between the first height and the sum of the fifth height and the sixth height, and setting the battery status bar and the status bar to be in the non-transparent state with the predetermined color, in response to the third height being greater than a difference between the first height and a predetermined multiple of the sum of the fifth height and the sixth height but less than or equal to the difference between the first height and the sum of the fifth height and the sixth height, wherein the predetermined multiple is greater than or equal to 2; and
determining that the second height is equal to the third height, and setting an area of the first display area excluding the playback area to be in the non-transparent state with the predetermined color in response to the third height being less than or equal to the difference between the first height and the predetermined multiple of the sum of the fifth height and the sixth height.

5. The method of claim 2, further comprising:
determining whether subtitles need to be clipped based on a position of the subtitles in response to recognizing that the video contains the subtitles; and
clipping the subtitles and fitting the video based on a width of the first display area, in response to determining that the subtitles need to be clipped.

6. The method of claim 5, wherein the playback parameter is a second height of a playback area for playing the video and in a case that the first height is less than the predetermined threshold and the navigation bar is in the transparent state, said generating a playback parameter of a video to be played in response to the attribute comprising at least one of:
determining that the second height is equal to a difference between the first height and a fifth height of the battery status bar, setting a battery status bar to be in the non-transparent state with the predetermined color and setting a status bar and the navigation bar to be in the transparent state, in response to a seventh height of an image area of the fitted video being greater than or equal to the difference between the first height and the fifth height but less than or equal to the first height;
determining that the second height is equal to a difference between the first height and a fourth height of the navigation bar, setting the battery status bar and the status bar to be in the transparent state and setting the navigation bar to be in the non-transparent state with the predetermined color, in response to the seventh height being greater than or equal to the difference between the first height and the fourth height but less than or equal to the difference between the first height and the fifth height;
determining that the second height is equal to a difference between the first height and a sum of the fourth height and the fifth height, setting the status bar to be in the transparent state and setting the battery status bar and the navigation bar to be in the non-transparent state with the predetermined color, in response to the seventh height being greater than the difference between the first height and the sum of the fourth height and the fifth height but less than or equal to the difference between the first height and the fourth height;
determining that the second height is equal to a difference between the first height and a sum of the fourth height, the fifth height and a sixth height of the status bar, and setting the battery status bar, the status bar and the navigation bar to be in the non-transparent state with the predetermined color, in response to the seventh height being greater than or equal to the difference between the first height and the sum of the fourth height, the fifth height and the sixth height but less than the difference between the first height and the sum of the fourth height and the fifth height; and
determining that the second height is equal to the seventh height, and setting an area of the first display area excluding the playback area to be in the non-transparent state with the predetermined color, in response to the seventh height being less than or equal to the difference between the first height and the sum of the fourth height, the fifth height and the sixth height but greater than a difference between the first height and a predetermined multiple of the sum of the fifth height and the sixth height, wherein the predetermined multiple is greater than or equal to 2.

7. The method of claim 5, wherein the playback parameter is a second height of a playback area for playing the video and in a case that the first height is greater than or equal to the predetermined threshold and the navigation bar is in the non-transparent state with the predetermined color, said generating a playback parameter of a video to be played in response to the attribute comprising at least one of:
determining that the second height is equal to a difference between the first height and a fifth height of the battery status bar, setting a battery status bar and the navigation bar to be in the non-transparent state with the predetermined color and setting a status bar to be in the transparent state, in response to a seventh height of an image area of the fitted video being greater than or equal to the difference between the first height and the fifth height but less than or equal to the first height;
determining that the second height is equal to a difference between the first height and a sum of a fourth height of the navigation bar and the fifth height, and setting the battery status bar, the status bar and the navigation bar to be in the non-transparent state with the predetermined color, in response to the seventh height being greater than or equal to a difference between the first height and the fourth height but less than or equal to the difference between the first height and the fifth height;
determining that the second height is equal to the seventh height, and setting an area of the first display area excluding the playback area to be in the non-transparent state with the predetermined color, in response to the seventh height being greater than a difference between the first height and a predetermined multiple of a sum of the fifth height and a sixth height of the status bar but less than the difference between the first height and the sum of the fifth height and the sixth height, wherein the predetermined multiple is greater than or equal to 2.

8. An electronic device, comprising:
a processor,
a memory, configured to store instructions executable by the processor;
wherein the processor is configured to execute the instructions to perform:
recognizing an attribute of a display control in a video playback interface;
generating a playback parameter of a video to be played in response to the attribute; and
playing the video in the video playback interface based on the playback parameter.

9. The electronic device of claim 8, said recognizing an attribute of a display control in a video playback interface comprising at least one of:
obtaining the attribute of the display control by recognizing a first height of a first display area of the display control, wherein the attribute of the display control is configured to indicate that the first height is less than a predetermined threshold or indicate that the first height is greater than or equal to the predetermined threshold;
obtaining the attribute of the display control by recognizing a state of a navigation bar, wherein the attribute of the display control is configured to indicate that the navigation bar is in a transparent state or indicate that the navigation bar is in a non-transparent state with a predetermined color.

10. The electronic device of claim 9, wherein, the playback parameter is a second height of a playback area for playing the video and in a case that the first height is less than the predetermined threshold and the navigation bar is in the transparent state, said generating a playback parameter of a video to be played in response to the attribute comprising at least one of:
fitting the video based on a width of the first display area, determining that the second height is equal to the first height and setting a battery status bar, a status bar and the navigation bar to be in the transparent state, in response to a third height of an image area of the video being greater than or equal to the first height;
scaling the video proportionally, determining that the second height is equal to the first height and setting the battery status bar, the status bar and the navigation bar to be in the transparent state, in response to the third height being greater than a difference between the first height and a fourth height of the navigation bar but less than or equal to the first height;
scaling the video proportionally, determining that the second height is equal to the difference between the first height and the fourth height, setting the battery status bar and the status bar to be in the transparent state and setting the navigation bar to be in the non-transparent state with the predetermined color, in response to the third height being greater than a difference between the first height and a sum of the fourth height and a fifth height of the battery status bar but less than or equal to the difference between the first height and the fourth height;
scaling the video proportionally, determining that the second height is equal to the difference between the first height and the fourth height, setting the battery status bar and the status bar to be in the transparent state and setting the navigation bar to be in the non-transparent state with the predetermined color, in response to the third height being greater than a difference between the first height and a sum of the fourth height, the fifth height and a sixth height of the status bar but less than or equal to the difference between the first height and the sum of the fourth height and the fifth height;
scaling the video proportionally, determining that the second height is equal to the difference between the first height and the sum of the fourth height, the fifth height and the sixth height, setting the battery status bar, the status bar and the navigation bar to be in the non-transparent state with the predetermined color, in response to the third height being greater than a difference between the first height and a predetermined multiple of a sum of the fifth height and the sixth height but less than or equal to the difference between the first height and the sum of the fourth height, the fifth height and the sixth height, wherein the predetermined multiple is greater than or equal to 2;
determining that the second height is equal to the third height, setting an area of the first display area excluding the playback area to be in the non-transparent state with the predetermined color, in response to the third height being less than or equal to the difference between the first height and the predetermined multiple of the sum of the fifth height and the sixth height.

11. The electronic device of claim 9, wherein the playback parameter is a second height of a playback area for playing the video and in a case that the first height is greater than or equal to the predetermined threshold and the navigation bar is in the non-transparent state with the predetermined color, said generating a playback parameter of a video to be played in response to the attribute comprising at least one of:
fitting the video based on a width of the first display area, determining that the second height is equal to the first height and setting a battery status bar and a status bar to be in the transparent state, in response to a third height of an image area of the video being greater than or equal to the first height;
scaling the video proportionally, determining that the second height is equal to the first height and setting the battery status bar and the status bar to be in the transparent state, in response to the third height being greater than a difference between the first height and a fifth height of the battery status bar but less than the first height;
scaling the video proportionally, determining that the second height is equal to the first height, and setting the battery status bar and the status bar to be in the transparent state, in response to the third height being greater than a difference between the first height and a sum of a sixth height of the status bar and the fifth height but less than or equal to the difference between the first height and the fifth height;
scaling the video proportionally, determining that the second height is equal to the difference between the first height and the sum of the fifth height and the sixth height, and setting the battery status bar and the status bar to be in the non-transparent state with the predetermined color, in response to the third height being greater than a difference between the first height and a predetermined multiple of the sum of the fifth height and the sixth height but less than or equal to the difference between the first height and the sum of the fifth height and the sixth height, wherein the predetermined multiple is greater than or equal to 2; and
determining that the second height is equal to the third height, and setting an area of the first display area excluding the playback area to be in the non-transparent state with the predetermined color in response to the third height being less than or equal to the difference between the first height and the predetermined multiple of the sum of the fifth height and the sixth height.

12. The electronic device of claim 9, wherein the processor is further configured to perform:
determining whether subtitles need to be clipped based on a position of the subtitles in response to recognizing that the video contains the subtitles; and
clipping the subtitles and fitting the video based on a width of the first display area, in response to determining that the subtitles need to be clipped.

13. The electronic device of claim 12, wherein the playback parameter is a second height of a playback area for playing the video and in a case that the first height is less than the predetermined threshold and the navigation bar is in the transparent state, said generating a playback parameter of a video to be played in response to the attribute comprising at least one of:
determining that the second height is equal to a difference between the first height and a fifth height of the battery status bar, setting a battery status bar to be in the non-transparent state with the predetermined color and setting a status bar and the navigation bar to be in the transparent state, in response to a seventh height of an image area of the fitted video being greater than or equal to the difference between the first height and the fifth height but less than or equal to the first height;
determining that the second height is equal to a difference between the first height and a fourth height of the navigation bar, setting the battery status bar and the status bar to be in the transparent state and setting the navigation bar to be in the non-transparent state with the predetermined color, in response to the seventh height being greater than or equal to the difference between the first height and the fourth height but less than or equal to the difference between the first height and the fifth height;
determining that the second height is equal to a difference between the first height and a sum of the fourth height and the fifth height, setting the status bar to be in the transparent state and setting the battery status bar and the navigation bar to be in the non-transparent state with the predetermined color, in response to the seventh height being greater than the difference between the first height and the sum of the fourth height and the fifth height but less than or equal to the difference between the first height and the fourth height;
determining that the second height is equal to a difference between the first height and a sum of the fourth height, the fifth height and a sixth height of the status bar, and setting the battery status bar, the status bar and the navigation bar to be in the non-transparent state with the predetermined color, in response to the seventh height being greater than or equal to the difference between the first height and the sum of the fourth height, the fifth height and the sixth height but less than the difference between the first height and the sum of the fourth height and the fifth height; and
determining that the second height is equal to the seventh height, and setting an area of the first display area excluding the playback area to be in the non-transparent state with the predetermined color, in response to the seventh height being less than or equal to the difference between the first height and the sum of the fourth height, the fifth height and the sixth height but greater than a difference between the first height and a predetermined multiple of the sum of the fifth height and the sixth height, wherein the predetermined multiple is greater than or equal to 2.

14. The electronic device of claim 12, wherein the playback parameter is a second height of a playback area for playing the video and in a case that the first height is greater than or equal to the predetermined threshold and the navigation bar is in the non-transparent state with the predetermined color, said generating a playback parameter of a video to be played in response to the attribute comprising at least one of:
determining that the second height is equal to a difference between the first height and a fifth height of the battery status bar, setting a battery status bar and the navigation bar to be in the non-transparent state with the predetermined color and setting a status bar to be in the transparent state, in response to a seventh height of an image area of the fitted video being greater than or equal to the difference between the first height and the fifth height but less than or equal to the first height;
determining that the second height is equal to a difference between the first height and a sum of a fourth height of the navigation bar and the fifth height, and setting the battery status bar, the status bar and the navigation bar to be in the non-transparent state with the predetermined color, in response to the seventh height being greater than or equal to a difference between the first height and the fourth height but less than or equal to the difference between the first height and the fifth height;
determining that the second height is equal to the seventh height, and setting an area of the first display area excluding the playback area to be in the non-transparent state with the predetermined color, in response to the seventh height being greater than a difference between the first height and a predetermined multiple of a sum of the fifth height and a sixth height of the status bar but less than the difference between the first height and the sum of the fifth height and the sixth height, wherein the predetermined multiple is greater than or equal to 2.

15. A non-transitory storage medium, wherein when instructions in the storage medium are executed by a processor of an electronic device, the electronic device is caused to perform:
recognizing an attribute of a display control in a video playback interface;
generating a playback parameter of a video to be played in response to the attribute; and
playing the video in the video playback interface based on the playback parameter.

16. The storage medium of claim 15, said recognizing an attribute of a display control in a video playback interface comprising at least one of:
obtaining the attribute of the display control by recognizing a first height of a first display area of the display control, wherein the attribute of the display control is configured to indicate that the first height is less than a predetermined threshold or indicate that the first height is greater than or equal to the predetermined threshold;
obtaining the attribute of the display control by recognizing a state of a navigation bar, wherein the attribute of the display control is configured to indicate that the navigation bar is in a transparent state or indicate that the navigation bar is in a non-transparent state with a predetermined color.

17. The storage medium of claim 16, wherein, the playback parameter is a second height of a playback area for playing the video and in a case that the first height is less than the predetermined threshold and the navigation bar is in the transparent state, said generating a playback parameter of a video to be played in response to the attribute comprising at least one of:
fitting the video based on a width of the first display area, determining that the second height is equal to the first height and setting a battery status bar, a status bar and the navigation bar to be in the transparent state, in response to a third height of an image area of the video being greater than or equal to the first height;
scaling the video proportionally, determining that the second height is equal to the first height and setting the battery status bar, the status bar and the navigation bar to be in the transparent state, in response to the third height being greater than a difference between the first height and a fourth height of the navigation bar but less than or equal to the first height;
scaling the video proportionally, determining that the second height is equal to the difference between the first height and the fourth height, setting the battery status bar and the status bar to be in the transparent state and setting the navigation bar to be in the non-transparent state with the predetermined color, in response to the third height being greater than a difference between the first height and a sum of the fourth height and a fifth height of the battery status bar but less than or equal to the difference between the first height and the fourth height;
scaling the video proportionally, determining that the second height is equal to the difference between the first height and the fourth height, setting the battery status bar and the status bar to be in the transparent state and setting the navigation bar to be in the non-transparent state with the predetermined color, in response to the third height being greater than a difference between the first height and a sum of the fourth height, the fifth height and a sixth height of the status bar but less than or equal to the difference between the first height and the sum of the fourth height and the fifth height;
scaling the video proportionally, determining that the second height is equal to the difference between the first height and the sum of the fourth height, the fifth height and the sixth height, setting the battery status bar, the status bar and the navigation bar to be in the non-transparent state with the predetermined color, in response to the third height being greater than a difference between the first height and a predetermined multiple of a sum of the fifth height and the sixth height but less than or equal to the difference between the first height and the sum of the fourth height, the fifth height and the sixth height, wherein the predetermined multiple is greater than or equal to 2;
determining that the second height is equal to the third height, setting an area of the first display area excluding the playback area to be in the non-transparent state with the predetermined color, in response to the third height being less than or equal to the difference between the first height and the predetermined multiple of the sum of the fifth height and the sixth height.

18. The storage medium of claim 16, wherein the playback parameter is a second height of a playback area for playing the video and in a case that the first height is greater than or equal to the predetermined threshold and the navigation bar is in the non-transparent state with the predetermined color, said generating a playback parameter of a video to be played in response to the attribute comprising at least one of:
fitting the video based on a width of the first display area, determining that the second height is equal to the first height and setting a battery status bar and a status bar to be in the transparent state, in response to a third height of an image area of the video being greater than or equal to the first height;
scaling the video proportionally, determining that the second height is equal to the first height and setting the battery status bar and the status bar to be in the transparent state, in response to the third height being greater than a difference between the first height and a fifth height of the battery status bar but less than the first height;
scaling the video proportionally, determining that the second height is equal to the first height, and setting the battery status bar and the status bar to be in the transparent state, in response to the third height being greater than a difference between the first height and a sum of a sixth height of the status bar and the fifth height but less than or equal to the difference between the first height and the fifth height;
scaling the video proportionally, determining that the second height is equal to the difference between the first height and the sum of the fifth height and the sixth height, and setting the battery status bar and the status bar to be in the non-transparent state with the predetermined color, in response to the third height being greater than a difference between the first height and a predetermined multiple of the sum of the fifth height and the sixth height but less than or equal to the difference between the first height and the sum of the fifth height and the sixth height, wherein the predetermined multiple is greater than or equal to 2; and
determining that the second height is equal to the third height, and setting an area of the first display area excluding the playback area to be in the non-transparent state with the predetermined color in response to the third height being less than or equal to the difference between the first height and the predetermined multiple of the sum of the fifth height and the sixth height.

19. The storage medium of claim 16, wherein the electronic device is further caused to perform:
determining whether subtitles need to be clipped based on a position of the subtitles in response to recognizing that the video contains the subtitles; and
clipping the subtitles and fitting the video based on a width of the first display area, in response to determining that the subtitles need to be clipped.

20. The storage medium of claim 19, wherein the playback parameter is a second height of a playback area for playing the video and in a case that the first height is less than the predetermined threshold and the navigation bar is in the transparent state, said generating a playback parameter of a video to be played in response to the attribute comprising at least one of:
determining that the second height is equal to a difference between the first height and a fifth height of the battery status bar, setting a battery status bar to be in the non-transparent state with the predetermined color and setting a status bar and the navigation bar to be in the transparent state, in response to a seventh height of an image area of the fitted video being greater than or equal to the difference between the first height and the fifth height but less than or equal to the first height;
determining that the second height is equal to a difference between the first height and a fourth height of the navigation bar, setting the battery status bar and the status bar to be in the transparent state and setting the navigation bar to be in the non-transparent state with the predetermined color, in response to the seventh height being greater than or equal to the difference between the first height and the fourth height but less than or equal to the difference between the first height and the fifth height;
determining that the second height is equal to a difference between the first height and a sum of the fourth height and the fifth height, setting the status bar to be in the transparent state and setting the battery status bar and the navigation bar to be in the non-transparent state with the predetermined color, in response to the seventh height being greater than the difference between the first height and the sum of the fourth height and the fifth height but less than or equal to the difference between the first height and the fourth height;
determining that the second height is equal to a difference between the first height and a sum of the fourth height, the fifth height and a sixth height of the status bar, and setting the battery status bar, the status bar and the navigation bar to be in the non-transparent state with the predetermined color, in response to the seventh height being greater than or equal to the difference between the first height and the sum of the fourth height, the fifth height and the sixth height but less than the difference between the first height and the sum of the fourth height and the fifth height; and
determining that the second height is equal to the seventh height, and setting an area of the first display area excluding the playback area to be in the non-transparent state with the predetermined color, in response to the seventh height being less than or equal to the difference between the first height and the sum of the fourth height, the fifth height and the sixth height but greater than a difference between the first height and a predetermined multiple of the sum of the fifth height and the sixth height, wherein the predetermined multiple is greater than or equal to 2.
